(19) United States
(12) Patent Application Publication
(10) Pub. No.: US 2025/0106712 A1
(43) Pub. Date: Mar. 27, 2025

(54) IMPROVEMENTS IN AND RELATING TO L1/L2-TRIGGERED MOBILITY (LTM) IN A TELECOMMUNICATION NETWORK

(71) Applicant: Samsung Electronics Co., Ltd., Suwon-si (KR)

(72) Inventor: Donggun KIM, Staines (GB)

(21) Appl. No.: 18/742,143

(22) Filed: Jun. 13, 2024

(30) Foreign Application Priority Data
Sep. 26, 2023 (GB) 2314736.6
May 8, 2024 (GB) 2406450.3

(51) Int. Cl. H04W 36/04

(52) U.S. Cl. CPC H04W 36/04

(57) ABSTRACT

The disclosure relates to a 5th generation (5G) or 6th generation (6G) communication system for supporting a higher data transmission rate. A method performed by a user equipment (UE) in a communication system is provided. The method includes receiving a radio resource control (RRC) message including a configuration of layer 1 (L1)/layer 2 (L2) triggered mobility (LTM) associated with a LTM cell switch procedure identifying that the LTM cell switch procedure is triggered, and releasing current dedicated radio configuration associated with a cell group for which the LTM cell switch procedure is triggered, wherein, in case that the LTM cell switch procedure is triggered on a master cell group (MCG), the current dedicated radio configuration is released except for an MCG cell-radio network temporary identifier (C-RNTI).

### CROSS-REFERENCE TO RELATED APPLICATION(S)

This application is based on and claims priority under 35 U.S.C. § 119(a) of a Great Britain patent application number 2314736.6, filed on Sep. 26, 2023, in the Great Britain Intellectual Property Office, and of a Great Britain patent application number 2406450.3, filed on May 8, 2024, in the Great Britain Intellectual Property Office, the disclosure of each of which is incorporated by reference herein in its entirety.

### BACKGROUND

### 1. Field

The disclosure relates to improvements in layer 1 (L1)/layer 2 (L2)-Triggered Mobility (LTM) in a telecommunication network.

### 2. Description of Related Art

5^{th} generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6^{th} generation (6G) mobile communication technologies (referred to as Beyond 5G systems) in terahertz (THz) bands (e.g., 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining Network Functions Virtualization (NFV) and Software-Defined Networking (SDN) technologies, and Mobile Edge Computing (MEC) for receiving services based on user equipment (UE) positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are address at least the above-mentioned problems and/or disadvantages and to provide at least the advantages described below. Accordingly, an aspect of the disclosure is to provide solutions to support LTM with low latency, low complexity and no user plane data loss. Embodiments also aim to take into account the impact on legacy behaviors to avoid conflicts therewith.

Another aspect of the disclosure is to provide methods to support LTM cell switch for a User Equipment (UE) configured with dual connectivity, e.g., LTM cell switch for Secondary Cell Group (SCG).

Another aspect of the disclosure is to provide several solutions to handle failure cases for LTM execution in order to recover quickly.

Another aspect of the disclosure is to provide an apparatus and method as set forth in the appended claims.

Additional aspects will be set forth in part in the description which follows and, in part, will be apparent from the description, or may be learned by practice of the presented embodiments.

In accordance with an aspect of the disclosure, a method performed by a user equipment (UE) in a communication system is provided. The method includes receiving a radio resource control (RRC) message including a configuration of layer 1 (L1)/layer 2 (L2) triggered mobility (LTM) identifying that the LTM cell switch procedure is triggered, and releasing current dedicated radio configuration associated with a cell group for which the LTM cell switch procedure is triggered, wherein, in case that the LTM cell switch procedure is triggered on a master cell group (MCG), the current dedicated radio configuration is released except for an MCG cell-radio network temporary identifier (C-RNTI).

In an embodiment, if LTM is triggered for the MN or MCG, then one of the other current dedicated radio configurations associated with a cell group for which the LTM procedure is triggered includes SCG C-RNTI.

In an embodiment, if LTM is triggered for the SN or SCG, then conditions for parameters set in an RRC message and instructions of a lower layer are satisfied only to trigger a random access procedure.

In an embodiment, upon receipt of an RRCReconfiguration message by the UE, determining if scg-State is included in the RRCReconfiguration message and if not, determining if reconfigurationWihSync is included in spCellConfig in nr-SCG and if the RRCReconfiguration message is not applied due to an LTM cell switch execution for which a lower layer indicates to skip the Random Access procedure, then initiate a Random Access procedure on the PSCell.

In accordance with another aspect of the disclosure, a user equipment (UE) in a communication system is provided, the UE including a transceiver, and a processor coupled with the transceiver and configured to receive a radio resource control (RRC) message including a configuration of layer 1 (L1)/layer 2 (L2) triggered mobility (LTM) associated with a LTM cell switch procedure, identify that the LTM cell switch procedure is triggered, and release current dedicated radio configuration associated with a cell group for which the LTM cell switch procedure is triggered, wherein, in case that the LTM cell switch procedure is triggered on a master cell group (MCG), the current dedicated radio configuration is released except for an MCG cell radio network temporary identifier (C-RNTI).

In accordance with another aspect of the disclosure, a method performed by a base station in a communication system. The method including obtaining a configuration of layer 1 (L1)/layer 2 (L2) triggered mobility (LTM) associated with a LTM cell switch procedure, and transmitting a radio resource control (RRC) message including the configuration, wherein, in case that the LTM cell switch procedure is triggered on a master cell group (MCG), a current dedicated radio configuration is released except for an MCG cell radio network temporary identifier (C-RNTI).

In accordance with another aspect of the disclosure, a base station in a communication system. The base station including a transceiver, and a processor coupled with the transceiver and configured to obtain a configuration of layer 1 (L1)/layer 2 (L2) triggered mobility (LTM) associated with a LTM cell switch procedure, and transmit a radio resource control (RRC) message including the configuration, wherein, in case that the LTM cell switch procedure is triggered on a master cell group (MCG), a current dedicated radio configuration is released except for an MCG cell radio network temporary identifier (C-RNTI).

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a signaling procedure for LTM according to an embodiment of the disclosure;

FIG. 2 shows a network configuration according to an embodiment of the disclosure;

FIG. 3 shows a flowchart according to an embodiment of the disclosure;

FIG. 4 illustrates an electronic device according to an embodiment of the disclosure; and

FIG. 5 illustrates a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

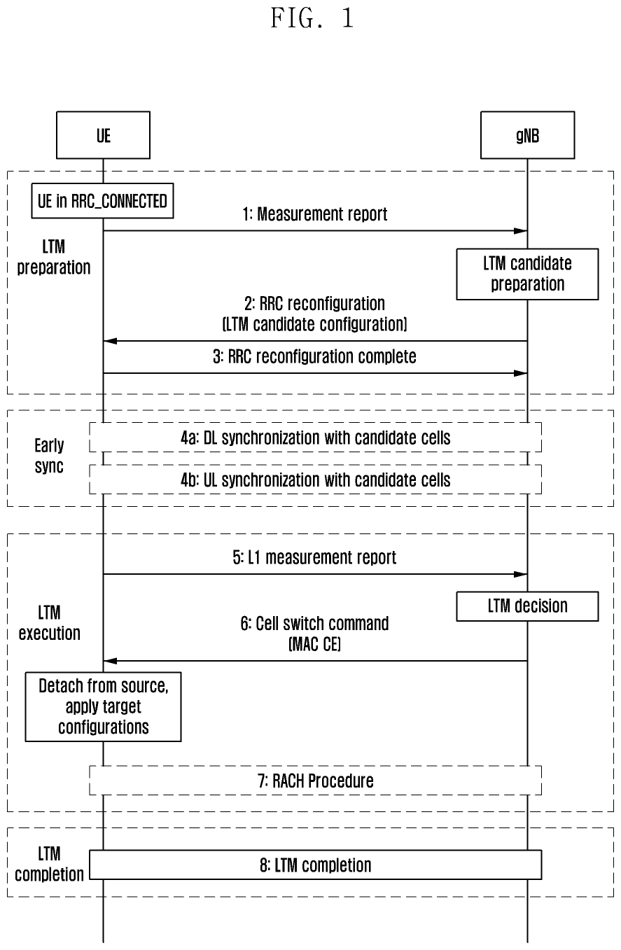

FIG. 1 shows a signaling procedure for LTM according to an embodiment of the disclosure.

Referring to FIG. 1, the procedure for LTM is as follows.

1. The UE sends a MeasurementReport message to the gNB. The gNB decides to use LTM and initiates candidate cell(s) preparation.

2. The gNB transmits an RRCReconfiguration message to the UE including the LTM candidate cell configurations of one or multiple candidate cells.

3. The UE stores the LTM candidate cell configurations and transmits a RRCReconfigurationComplete message to the gNB.

4a. The UE may perform DL synchronization with candidate cell(s) before receiving the cell switch command. DL synchronization for candidate cell(s) before cell switch command can be supported, at least based on SSB.

4b. The UE may perform early timing advance (TA) acquisition with candidate cell(s) requested by the network before receiving the cell switch command. This is done via Random access procedure (i.e., Contention-Free Random Access procedure, CFRA) triggered by a PDCCH order from the source cell, following which the UE sends preamble towards the indicated candidate cell. In order to minimize the data interruption of the source cell due to CFRA towards the candidate cell(s), the UE doesn't receive RAR for the purpose of TA value acquisition and the TA value of the candidate cell is indicated in the cell switch command. The UE doesn't maintain the TA timer for the candidate cell and relies on network implementation to guarantee the TA validity.

Synchronization for candidate cell(s) before cell switch command is supported, at least based on SSB.

TA acquisition of candidate cell(s) before LTM cell switch command is supported, at least based on PDCCH ordered RACH, where the PDCCH order is only triggered by source cell. The source cell can trigger UE's Random Access Procedure (RACH) toward a candidate cell by PDCCH order to acquire Timing Advance or Timing Advance value (TA) for the candidate cell, which only performs preamble transmission and does not expect the reception of Random Access Response (RAR) to ease network implementation and UE implementation. Specifically, the preamble transmission during this Random Access procedure (RACH) for TA acquisition (i.e., early RACH) can be considered as this Random Access procedure is successfully completed. To reduce the processing complexity, UE does not have to calculate RNTI Radio Network Temporary Identifier (RA-RNTI) for Random Access Response) before/when the preamble is transmitted, unlike normal Random Access procedure (RACH). To be more specific, UE transmits preamble to a candidate cell as indicated by PDCCH order. The network (or Distributed Unit (DU)) or the candidate cell) calculates the Timing Advance (TA). The source cell/DU can get the calculated TA from the candidate cell/DU. By doing this Random Access procedure (RACH) for TA acquisition (i.e., early RACH), the network can have the TA values for the candidate cells and knows whether these TAs are still valid or not, e.g., by maintaining a network side timer (i.e., timeAlignmentTimer (TAT)) for each TA value or each candidate cell). In this way, the source cell/DU gets to know the value and the validity of candidate cell TA. The source cell/DU needs to know whether a candidate cell TA is still valid because the source cell/DU needs to determine whether it can initiate a RACH-less solution for LTM cell switch and then determine whether it needs to include a beam indication (e.g., TCI state) and TA information in the LTM MAC CE. Therefore, the network can indicate a valid TA to the UE or indicate whether a TA is still valid in LTM MAC CE. The UE may not need to maintain a TA timer for candidate cells, which simplifies UE implementation. Upon the reception of the TA information indicated in LTM MAC CE, the UE can apply the TA value and start the TA timer for the target LTM candidate cell upon LTM execution (i.e., LTM cell switch) and UE can perform LTM cell switch without Random access procedure (i.e., with RACH-less solution to skip the Random access procedure) if TAT for the target LTM candidate cell is running (i.e., TA value is valid) or if Beam failure is not detected for the target LTM candidate cell, which means that UE can monitor PDCCH from the target LTM candidate cell or UE can use configured grants the first uplink (UL) data transmission to the target cell for RACH-less LTM execution (LTM cell switch).

5. The UE performs L1 measurements on the configured candidate cell(s), and transmits lower-layer measurement reports to the gNB.

6. The gNB decides to execute cell switch to a target cell, and transmits a MAC CE triggering cell switch by including the candidate configuration index of the target cell. The UE switches to the configuration of the target cell.

7. The UE performs random access procedure towards the target cell, if cell switch needs to include performing random access procedure.

8. The UE completes the LTM cell switch procedure by sending RRCReconfigurationComplete message to target cell. If the UE has performed a RA procedure in step 7, the UE considers that LTM execution is successfully completed when the random access procedure is successfully completed. For RACH-less LTM, the UE considers that LTM execution is successfully completed when the UE determines that the network has successfully received its first UL data. The UE determines successful reception of its first UL data by receiving a PDCCH addressing the UE's C-RNTI in the target cell, which schedules a new transmission following the first UL data.

The UE can perform the steps 4-8 multiple times for subsequent LTM cell switch based on the configuration provided in step 2.

The LTM cell switch procedure has mainly been designed for UEs configured with a single connectivity, i.e., a single connection with one gNB. In New Radio (NR), having UEs configured with dual connectivity (DC) is common due to the coexistence of Long Term Evolution (LTE) and NR and the high requirement on data rate and low latency, i.e., two connections are provided for the UE, with Master Cell Group (MCG) or Master Node (MN) and SCG (Secondary Cell Group or SN (Secondary Node)). In general, a UE has different Radio Resource Control (RRC) procedures towards MCG and SCG, separately.

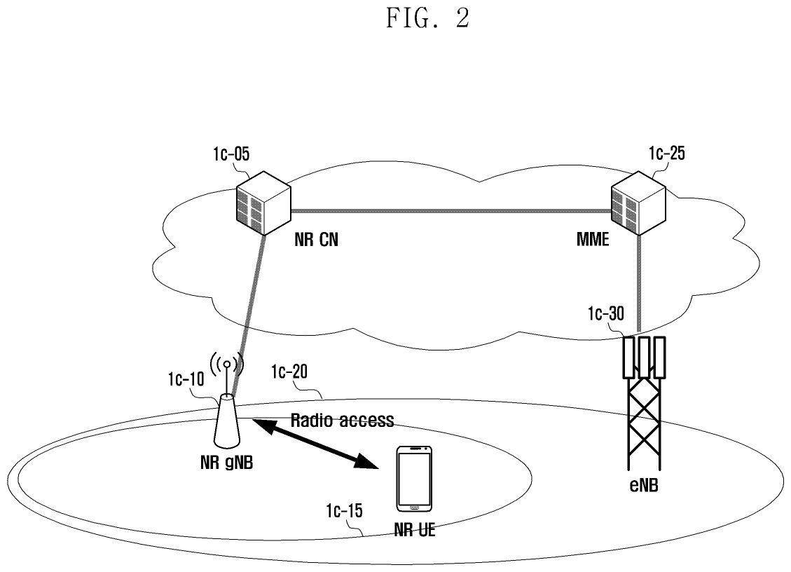

FIG. 2 shows a generic view of a DC configured network, including NR-gNB and LTE eNB and associated network components, as well as a UE according to an embodiment of the disclosure.

Referring to FIG. 2, the radio access network of the next-generation mobile communication system (hereinafter, referred to as NR or 5G) includes a NR gNB or NR base station 1c-10 and a new radio core network (NR CN) 1c-05, as illustrated. A new radio user equipment (hereinafter, referred to as NR UE or terminal) 1c-15 accesses an external network through the NR gNB 1c-10 and the NR CN 1c-05.

In FIG. 2, the NR gNB 1c-10 corresponds to an evolved Node B (eNB) of an existing LTE system. The NR gNB is connected to the NR UE 1c-15 through a wireless channel, and is capable of providing a better service than an existing node B. In the next-generation mobile communication system, all user traffics are provided through a shared channel, and there is accordingly a need for a device for aggregating and scheduling status information such as the buffer status of UEs, the available transmission power status, and the channel status, and the same is handled by the NR gNB 1c-10.

A single NR gNB normally controls multiple cells. In order to implement super-high data transmission compared with the current LTE, the next-generation mobile communication system may have at least the existing maximum bandwidth, and a beamforming technology may be additionally combined, based OFDM as a radio access technology. In addition, an AMC scheme is applied, which determines the modulation scheme and the channel coding rate according to the channel status of the UE.

The NR CN 1c-05 performs functions such as mobility support, bearer configuration, and QoS configuration. The NR CN is a device in charge of not only the UE mobility management function, but also various control functions, and is connected to multiple base stations. In addition, the next-generation mobile communication system may interwork with an existing LTE system, and the NR CN is connected to an MME 1c-25 through a network interface. The MME is connected to an eNB 1c-30, which is an existing base station.

Referring to FIG. 2, in an embodiment of the disclosure, a UE is configured with dual connectivity, i.e., LTM cell switch procedure is supported for MCG and SCG, independently, and several solutions are described to achieve this.

Firstly, the MCG should not be involved in LTM cell switch procedure for SCG to make it simple. However, given that SCG configuration can be sent via SRB1 (i.e., MCG), the UE should avoid triggering the corresponding actions related to SCG parameters if the parameters are received from MCG. One of the critical parameters is “reconfigurationwithsync”, which automatically triggers a random access (RA) procedure in SCG Medium Access Control (MAC) entity. To avoid this unintended behavior, conditions relating to LTM candidate configuration and associated procedure follow later.

In addition to this, the UE keeps MCG Cell-Radio Network Temporary Identifier (C-RNTI) upon LTM cell switch execution for MCG while the UE releases SCG C-RNTI upon LTM cell switch execution for SCG to save UE memory. This is because MCG C-RNTI may be used at Radio Link Failure (RLF) or RRC Re-establishment but it is not worth keeping SCG C-RNTI, as set out later.

The following relates to RRC Reconfiguration. The purpose of this procedure is to modify an RRC connection, e.g., to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional handover configuration, to add/modify/release conditional PSCell change or conditional PSCell addition configuration, to add/modify/LTM candidate cells. As part of the procedure, NAS dedicated information may be transferred from the Network to the UE.

RRC reconfiguration to perform reconfiguration with sync includes, but is not limited to, the following cases:
reconfiguration with sync and security key refresh, involving RA to the Pcell/PSCell, MAC reset, refresh of security and re-establishment of RLC and PDCP triggered by explicit L2 indicators;
reconfiguration with sync but without security key refresh, involving RA to the Pcell/PSCell, MAC reset and RLC re-establishment and PDCP data recovery (for AM DRB or AM MRB) triggered by explicit L2 indicators.
reconfiguration with sync for DAPS and security key refresh, involving RA to the target Pcell, establishment of target MAC, and
for non-DAPS bearer: refresh of security and re-establishment of RLC and PDCP triggered by explicit L2 indicators;
for DAPS bearer: establishment of RLC for the target Pcell, refresh of security and reconfiguration of PDCP to add the ciphering function, the integrity protection function and ROHC function of the target Pcell;
for SRB: refresh of security and establishment of RLC and PDCP for the target Pcell;
reconfiguration with sync for DAPS but without security key refresh, involving RA to the target Pcell, establishment of target MAC, and
for non-DAPS bearer: RLC re-establishment and PDCP data recovery (for AM DRB or AM MRB) triggered by explicit L2 indicators.
for DAPS bearer: establishment of RLC for target Pcell, reconfiguration of PDCP to add the ciphering function, the integrity protection function and ROHC function of the target Pcell;
for SRB: establishment of RLC and PDCP for the target Pcell.
reconfiguration with sync for direct-to-indirect path switch, not involving RA at target side, involving re-establishment of PDCP/PDCP data recovery (for AM DRB) triggered by explicit L2 indicators.

In (NG) EN-DC and NR-DC, SRB3 can be used for measurement configuration and reporting, for UE assistance (re-)configuration and reporting for power savings, for IP address (re-)configuration and reporting for IAB-nodes, to (re-)configure MAC, RLC, BAP, physical layer and RLF timers and constants of the SCG configuration, and to reconfigure PDCP for DRBs associated with the S-KgNB or SRB3, and to reconfigure SDAP for DRBs associated with S-KgNB in NGEN-DC and NR-DC, and to add/modify/release conditional PSCell change configuration, provided that the (re-)configuration does not require any MN involvement, and to transmit RRC messages between the MN and the UE during fast MCG link recovery. In (NG)EN-DC and NR-DC, only measConfig, radioBearerConfig, conditionalReconfiguration, bap-Config, iab-IP-AddressConfigurationList, otherConfig and/or secondaryCellGroup are included in RRCReconfiguration received via SRB3, except when RRCReconfiguration is received within DLInformationTransferMRDC.

The Network may initiate the RRC reconfiguration procedure to a UE in RRC_CONNECTED. The Network applies the procedure as follows:
the establishment of RBs (other than SRB1, that is established during RRC connection establishment) is performed only when AS security has been activated;
the establishment of BH RLC Channels for IAB is performed only when AS security has been activated;
the establishment of Uu Relay RLC channels and PC5 Relay RLC channels (other than SL-RLC0 and SL-RLC1) for L2 U2N Relay UE is performed only when AS security has been activated, and the establishment of PC5 Relay RLC channels for L2 U2N Remote UE (other than SL-RLC0 and SL-RLC1) is performed only when AS security has been activated;
the addition of Secondary Cell Group and SCells is performed only when AS security has been activated;
the reconfigurationWithSync is included in secondaryCellGroup only when at least one RLC bearer or BH RLC channel is setup in SCG;
the reconfigurationWithSync is included in masterCellGroup only when AS security has been activated, and SRB2 with at least one DRB or multicast MRB or, for IAB, SRB2, are setup and not suspended;
the conditionalReconfiguration for CPC is included only when at least one RLC bearer is setup in SCG;
the conditionalReconfiguration for CHO or CPA is included only when AS security has been activated, and SRB2 with at least one DRB or multicast MRB or, for IAB, SRB2, are setup and not suspended.
the ltm-CandidateConfig (LTM candidate cell configuration) for LTM is included only when AS security has been activated, and SRB2 with at least one DRB are setup and not suspended.

The UE shall perform the following actions upon reception of the RRCReconfiguration, or upon execution of the conditional reconfiguration (CHO, CPA or CPC):

For LTM cell switch, how to generate the RRCReconfigurationComplete message is proposed in the following.

Option 1. The RRCReconfigurationComplete message is generated upon the reception of LTM triggering MAC CE (or LTM cell switch execution) and then is sent to the target cell during LTM cell switch procedure (e.g., by Message 3 if random access procedure is performed or uplink data transmission if random access procedure is skipped (or not performed, i.e., RACH-less case). This Option 1 makes UE implementation simple because UE cannot know to which cell UE will perform LTM cell switch in advance.

NOTE: To reduce the processing delay for generation of RRCReconfiguration complete, UE may generate the RRCReconfigurationComplete message for each LTM candidate cell configuration upon the reception of RRCReconfiguration message including the ltm-CandidateConfig (LTM candidate cell configuration) in advance, i.e., UE can decide to send one of RRCReconfiguationComplete messages based on the received LTM triggering MAC CE in MAC entity for LTM cell switch procedure.
1> if the LTM cell switch is triggered from lower layers (e.g., by receiving the LTM triggering MAC CE in MAC entity or LTM cell switch execution) or if the target LTM candidate cell configuration is applied due to a LTM candidate cell execution (In another embodiment, the second RRCReconfigurationComplete message can be generated when the LTM cell switch (LTM execution) is successfully completed.):
2> set the content of the RRCReconfigurationComplete message as follows:
3> include the LTM candidate cell configuration/information (e.g., cell identity or UE identity or configuration index or configuration identity) for the target cell indicated from lower layers (e.g., as indicated by LTM triggering MAC CE)

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
1> if the RRCReconfiguration message includes the ltm-CandidateConfig (LTM candidate cell configuration):
2> perform the LTM configuration procedure as specified in 3.3.1.3;
1> set the content of the RRCReconfigurationComplete message as follows if the RRCReconfiguration message does not include the ltm-CandidateConfig (LTM candidate cell configuration):

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
2> if the RRCReconfiguration includes the masterCellGroup containing the reportUplinkTxDirectCurrent:
3> include the uplinkTxDirectCurrentList for each MCG serving cell with UL;
3> include uplinkDirectCurrentBWP-SUL for each MCG serving cell configured with SUL carrier, if any, within the uplinkTxDirectCurrentList;
2> if the RRCReconfiguration includes the masterCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the MCG;
2> if the RRCReconfiguration includes the masterCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the MCG;
2> if the RRCReconfiguration includes the secondaryCellGroup containing the reportUplinkTxDirectCurrent:
3> include the uplinkTxDirectCurrentList for each SCG serving cell with UL;
3> include uplinkDirectCurrentBWP-SUL for each SCG serving cell configured with SUL carrier, if any, within the uplinkTxDirectCurrentList;
2> if the RRCReconfiguration includes the secondaryCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the SCG;
2> if the RRCReconfiguration includes the secondaryCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the SCG;

NOTE 0b: The UE does not expect that the reportUplinkTxDirectCurrentTwoCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier or reportUplinkTxDirectCurrentMoreCarrier in one RRC message.
2> if the RRCReconfiguration message includes the mrdc-SecondaryCellGroupConfig with mrdc-SecondaryCellGroup set to eutra-SCG:
3> include in the eutra-SCG-Response the E-UTRA RRCConnectionReconfigurationComplete message in accordance with TS 36.331 clause 5.3.5.3;

2> if the RRCReconfiguration message includes the mrdc-SecondaryCellGroupConfig with mrdc-SecondaryCellGroup set to nr-SCG:
3> include in the nr-SCG-Response the SCG RRCReconfigurationComplete message;
3> if the RRCReconfiguration message is applied due to conditional reconfiguration execution and the RRCReconfiguration message does not include the reconfigurationWithSync in the masterCellGroup:
4> include in the selectedCondRRCReconfig the condReconfigId for the selected cell of conditional reconfiguration execution;
2> if the RRCReconfiguration includes the reconfigurationWithSync in spCellConfig of an MCG:
3> if the UE has logged measurements available for NR and if the RPLMN is included in plmn-IdentityList stored in VarLogMeasReport:
4> include the logMeasAvailable in the RRCReconfigurationComplete message;
4> if Bluetooth measurement results are included in the logged measurements the UE has available for NR:
5> include the logMeasAvailableBT in the RRCReconfigurationComplete message;
4> if WLAN measurement results are included in the logged measurements the UE has available for NR:
5> include the logMeasAvailableWLAN in the RRCReconfigurationComplete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfigurationComplete message;
3> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
4> include connEstFailInfoAvailable in the RRCReconfigurationComplete message;
3> if the UE has radio link failure or handover failure information available in VarRLF-Report and if the RPLMN is included in plmn-IdentityList stored in VarRLF-Report; or
3> if the UE has radio link failure or handover failure information available in VarRLF-Report of TS 36.331 [10] and if the UE is capable of cross-RAT RLF reporting and if the RPLMN is included in plmn-IdentityList stored in VarRLF-Report of TS 36.331 [10]:
4> include rlf-InfoAvailable in the RRCReconfigurationComplete message;
3> if the UE was configured with successHO-Config when connected to the source Pcell; and
3> if the applied RRCReconfiguration is not due to a conditional reconfiguration execution upon cell selection performed while timer T311 was running, as defined in 5.3.7.3:

4> perform the actions for the successful handover report determination as specified in clause 5.7.10.6, upon successfully completing the Random Access procedure triggered for the reconfigurationWithSync in spCellConfig of the MCG;
3> if the UE has successful handover information available in VarSuccessHO-Report and if the RPLMN is included in plmn-IdentityList stored in VarSuccessHO-Report:
4> include successHO-InfoAvailable in the RRCReconfigurationComplete message;
2> if the RRCReconfiguration message was received via SRB1, but not within mrdc-SecondaryCellGroup or E-UTRA RRCConnectionReconfiguration or E-UTRA RRCConnectionResume:
3> if the UE is configured to provide the measurement gap requirement information of NR target bands:
4> if the RRCReconfiguration message includes the needForGapsConfigNR; or
4> if the NeedForGapsInfoNR information is changed compared to last time the UE reported this information:
5> include the NeedForGapsInfoNR and set the contents as follows:
6> include intraFreq-needForGap and set the gap requirement information of intra-frequency measurement for each NR serving cell;
6> if requestedTargetBandFilterNR is configured:
7> for each supported NR band that is also included in requestedTargetBandFilterNR, include an entry in interFreq-needForGap and set the gap requirement information for that band;
6> else:
7> include an entry in interFreq-needForGap and set the corresponding gap requirement information for each supported NR band;
3> if the UE is configured to provide the measurement gap and NCSG requirement information of NR target bands:
4> if the RRCReconfiguration message includes the needForGapNCSG-ConfigNR; or
4> if the needForGapNCSG-InfoNR information is changed compared to last time the UE reported this information:
5> include the NeedForGapNCSG-InfoNR and set the contents as follows:
6> include intraFreq-needForNCSG and set the gap and NCSG requirement information of intra-frequency measurement for each NR serving cell;
6> if requestedTargetBandFilterNCSG-NR is configured:
7> for each supported NR band included in requestedTargetBandFilterNCSG-NR, include an entry in interFreq-needForNCSG and set the NCSG requirement information for that band;
6> else:
7> include an entry for each supported NR band in interFreq-needForNCSG and set the corresponding NCSG requirement information;
3> if the UE is configured to provide the measurement gap and NCSG requirement information of E UTRA target bands:
4> if the RRCReconfiguration message includes the needForGapNCSG-ConfigEUTRA; or
4> if the needForGapNCSG-InfoEUTRA information is changed compared to last time the UE reported this information:
5> include the NeedForGapNCSG-InfoEUTRA and set the contents as follows:
6> if requestedTargetBandFilterNCSG-EUTRA is configured, for each supported E-UTRA band included in requestedTargetBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;
2> if this procedure is initiated due to the generation of a complete LTM candidate cell configuration:
3> the procedure ends.

Option 2. Upon the reception of RRCReconfiguation, RRCReconfiguationComplete is generated corresponding to the RRCReconfiguration, and sent to the source cell (serving cell or the current cell UE received the RRCReconfiguration from). Another RRCReconfigurationComplete message is generated upon the reception of LTM triggering MAC CE (or LTM cell switch execution) and then is sent to the target cell during LTM cell switch procedure (e.g., by Message 3 if random access procedure is performed or uplink data transmission if random access procedure is skipped (or not performed, i.e., RACH-less case). This Option 2 has the network know the successful delivery of RRCReconfiguration and makes UE implementation simple because UE cannot know to which cell UE will perform LTM cell switch in advance.

NOTE: To reduce the processing delay for generation of RRCReconfiguration complete, UE may generate the RRCReconfigurationComplete message for each LTM candidate cell configuration upon the reception of RRCReconfiguration message including the ltm-CandidateConfig (LTM candidate cell configuration) in advance, i.e., UE can decide to send one of RRCReconfiguationComplete messages based on the received LTM triggering MAC CE in MAC entity for LTM cell switch procedure.
1> if the LTM cell switch is triggered from lower layers (e.g., by receiving the LTM triggering MAC CE in MAC entity or LTM cell switch execution) or if the target LTM candidate cell configuration is applied due to a LTM candidate cell execution (In another embodiment, the second RRCReconfigurationComplete message can be generated when the LTM cell switch (LTM execution) is successfully completed.):
2> set the content of the RRCReconfigurationComplete message as follows:
3> include the LTM candidate cell configuration/information (e.g., cell identity or UE identity or configuration index or configuration identity) for the target cell indicated from lower layers (e.g., as indicated by LTM triggering MAC CE)

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
1> if the RRCReconfiguration message includes the ltm-CandidateConfig (LTM candidate cell configuration):
2> perform the LTM configuration procedure as specified in 3.3.1.3;
2> set the content of the RRCReconfigurationComplete message as follows:

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
2> if the RRCReconfiguration includes the masterCellGroup containing the reportUplinkTxDirectCurrent:
3> include the uplinkTxDirectCurrentList for each MCG serving cell with UL;
3> include uplinkDirectCurrentBWP-SUL for each MCG serving cell configured with SUL carrier, if any, within the uplinkTxDirectCurrentList;
2> if the RRCReconfiguration includes the masterCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the MCG;
2> if the RRCReconfiguration includes the masterCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the MCG;
2> if the RRCReconfiguration includes the secondaryCellGroup containing the reportUplinkTxDirectCurrent:
3> include the uplinkTxDirectCurrentList for each SCG serving cell with UL;
3> include uplinkDirectCurrentBWP-SUL for each SCG serving cell configured with SUL carrier, if any, within the uplinkTxDirectCurrentList;
2> if the RRCReconfiguration includes the secondaryCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the SCG;
2> if the RRCReconfiguration includes the secondaryCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the SCG;

NOTE 0b: The UE does not expect that the reportUplinkTxDirectCurrentTwoCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier or reportUplinkTxDirectCurrentMoreCarrier in one RRC message.
2> if the RRCReconfiguration message includes the mrdc-SecondaryCellGroupConfig with mrdc-SecondaryCellGroup set to eutra-SCG:
3> include in the eutra-SCG-Response the E-UTRA RRCConnectionReconfigurationComplete message in accordance with TS 36.331 clause 5.3.5.3;
2> if the RRCReconfiguration message includes the mrdc-SecondaryCellGroupConfig with mrdc-SecondaryCellGroup set to nr-SCG:
3> include in the nr-SCG-Response the SCG RRCReconfigurationComplete message;
3> if the RRCReconfiguration message is applied due to conditional reconfiguration execution and the RRCReconfiguration message does not include the reconfigurationWithSync in the masterCellGroup:
4> include in the selectedCondRRCReconfig the condReconfigId for the selected cell of conditional reconfiguration execution;
2> if the RRCReconfiguration includes the reconfigurationWithSync in spCellConfig of an MCG:
3> if the UE has logged measurements available for NR and if the RPLMN is included in plmn-IdentityList stored in VarLogMeasReport:
4> include the logMeasAvailable in the RRCReconfigurationComplete message;
4> if Bluetooth measurement results are included in the logged measurements the UE has available for NR:
5> include the logMeasAvailableBT in the RRCReconfigurationComplete message;
4> if WLAN measurement results are included in the logged measurements the UE has available for NR:
5> include the logMeasAvailableWLAN in the RRCReconfigurationComplete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfigurationComplete message;
3> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
4> include connEstFailInfoAvailable in the RRCReconfigurationComplete message;
3> if the UE has radio link failure or handover failure information available in VarRLF-Report and if the RPLMN is included in plmn-IdentityList stored in VarRLF-Report; or
3> if the UE has radio link failure or handover failure information available in VarRLF-Report of TS 36.331 [10] and if the UE is capable of cross-RAT RLF reporting and if the RPLMN is included in plmn-IdentityList stored in VarRLF-Report of TS 36.331:
4> include rlf-InfoAvailable in the RRCReconfigurationComplete message;
3> if the UE was configured with successHO-Config when connected to the source Pcell; and
3> if the applied RRCReconfiguration is not due to a conditional reconfiguration execution upon cell selection performed while timer T311 was running, as defined in 5.3.7.3:
4> perform the actions for the successful handover report determination as specified in clause 5.7.10.6, upon successfully completing the Random Access procedure triggered for the reconfigurationWithSync in spCellConfig of the MCG;
3> if the UE has successful handover information available in VarSuccessHO-Report and if the RPLMN is included in plmn-IdentityList stored in VarSuccessHO-Report:
4> include successHO-InfoAvailable in the RRCReconfigurationComplete message;
2> if the RRCReconfiguration message was received via SRB1, but not within mrdc-SecondaryCellGroup or E-UTRA RRCConnectionReconfiguration or E-UTRA RRCConnectionResume:
3> if the UE is configured to provide the measurement gap requirement information of NR target bands:
4> if the RRCReconfiguration message includes the needForGapsConfigNR; or
4> if the NeedForGapsInfoNR information is changed compared to last time the UE reported this information:
5> include the NeedForGapsInfoNR and set the contents as follows:
6> include intraFreq-needForGap and set the gap requirement information of intra-frequency measurement for each NR serving cell;
6> if requestedTargetBandFilterNR is configured:
7> for each supported NR band that is also included in requestedTargetBandFilterNR, include an entry in interFreq-needForGap and set the gap requirement information for that band;
6> else:
7> include an entry in interFreq-needForGap and set the corresponding gap requirement information for each supported NR band;
3> if the UE is configured to provide the measurement gap and NCSG requirement information of NR target bands:
4> if the RRCReconfiguration message includes the needForGapNCSG-ConfigNR; or
4> if the needForGapNCSG-InfoNR information is changed compared to last time the UE reported this information:
5> include the NeedForGapNCSG-InfoNR and set the contents as follows:
6> include intraFreq-needForNCSG and set the gap and NCSG requirement information of intra-frequency measurement for each NR serving cell;
6> if requestedTargetBandFilterNCSG-NR is configured:
7> for each supported NR band included in requestedTargetBandFilterNCSG-NR, include an entry in interFreq-needForNCSG and set the NCSG requirement information for that band;
6> else:
7> include an entry for each supported NR band in interFreq-needForNCSG and set the corresponding NCSG requirement information;
3> if the UE is configured to provide the measurement gap and NCSG requirement information of E UTRA target bands:
4> if the RRCReconfiguration message includes the needForGapNCSG-ConfigEUTRA; or
4> if the needForGapNCSG-InfoEUTRA information is changed compared to last time the UE reported this information:
5> include the NeedForGapNCSG-InfoEUTRA and set the contents as follows:
6> if requestedTargetBandFilterNCSG-EUTRA is configured, for each supported E-UTRA band included in requestedTargetBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;
2> if this procedure is initiated due to the generation of a complete LTM candidate cell configuration:
3> the procedure ends.

Option 3. Upon the reception of RRCReconfiguation, RRCReconfiguationComplete is generated corresponding to the RRCReconfiguration, and sent to the source cell (serving cell or the current cell UE received the RRCReconfiguration from). A RRCReconfigurationComplete message is generated and sent to the target LTM cell if the Random Access procedure is triggered upon the reception of LTM triggering MAC CE (or LTM cell switch execution) (e.g., by Message 3). However, the RRCReconfigurationComplete message is not generated and not sent to the target LTM Cell if the random access procedure is not triggered or not performed (i.e., skipped (RACH-less case) upon the reception of LTM triggering MAC CE (or LTM cell switch execution). UE can perform the uplink data transmission without RRCReconfigurationComplete message (i.e., only with user plane data). This Option 3 reduces the signaling overhead on top of the benefits of Option2.

NOTE: To reduce the processing delay for generation of RRCReconfiguration complete, UE may generate the RRCReconfigurationComplete message for each LTM candidate cell configuration upon the reception of RRCReconfiguration message including the ltm-CandidateConfig (LTM candidate cell configuration) in advance, i.e., UE can decide to send one of RRCReconfiguationComplete messages based on the received LTM triggering MAC CE in MAC entity for LTM cell switch procedure.
3> if the LTM cell switch is triggered from lower layers (e.g., by receiving the LTM triggering MAC CE in MAC entity or LTM cell switch execution) or if the target LTM candidate cell configuration is applied due to a LTM candidate cell execution or the Random Access procedure is triggered (or if lower layers (i.e., MAC layer) indicate that a Random Access procedure is needed for LTM Cell execution or if BFI_COUNTER>=beamFailurelnstanceMaxCount for the target LTM candidate cell or the timeAlignmentTimer associated with the target LTM candidate cell (or TAG that the target LTM cell belongs to) is not running or if the first MAC CE does not include TA value (i.e., Timing Advance Command) or if the first MAC CE indicates that a Random access procedure is needed by indicator (e.g., special TA value)) (In another embodiment, the second RRCReconfigurationComplete message can be generated when the LTM cell switch (LTM execution) is successfully completed.):
2> set the content of the RRCReconfigurationComplete message as follows:
3> include the LTM candidate cell configuration/information (e.g., cell identity or UE identity or configuration index or configuration identity) for the target cell indicated from lower layers (e.g., as indicated by LTM triggering MAC CE)

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
1> if the RRCReconfiguration message includes the ltm-CandidateConfig (LTM candidate cell configuration):
2> perform the LTM configuration procedure as specified in 3.3.1.3;
4> set the content of the RRCReconfigurationComplete message as follows:

NOTE: In case this procedure is initiated due to the generation of a complete LTM candidate cell configuration, the UE should generate only one RRCReconfigurationComplete message even if it process the LTM reference configuration and a LTM candidate cell configuration. The RRCReconfigurationComplete message includes the contents for the target cell indicated by LTM triggering MAC CE.
2> if the RRCReconfiguration includes the masterCellGroup containing the reportUplinkTxDirectCurrent:
3> include the uplinkTxDirectCurrentList for each MCG serving cell with UL;
3> include uplinkDirectCurrentBWP-SUL for each MCG serving cell configured with SUL carrier, if any, within the uplinkTxDirectCurrentList;
2> if the RRCReconfiguration includes the masterCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the MCG;
2> if the RRCReconfiguration includes the masterCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the MCG;
2> if the RRCReconfiguration includes the secondaryCellGroup containing the reportUplinkTxDirectCurrent:
3> include the uplinkTxDirectCurrentList for each SCG serving cell with UL;
3> include uplinkDirectCurrentBWP-SUL for each SCG serving cell configured with SUL carrier, if any, within the uplinkTxDirectCurrentList;
2> if the RRCReconfiguration includes the secondaryCellGroup containing the reportUplinkTxDirectCurrentTwoCarrier:
3> include in the uplinkTxDirectCurrentTwoCarrierList the list of uplink Tx DC locations for the configured intra-band uplink carrier aggregation in the SCG;
2> if the RRCReconfiguration includes the secondaryCellGroup containing the reportUplinkTxDirectCurrentMoreCarrier:
3> include in the uplinkTxDirectCurrentMoreCarrierList the list of uplink Tx DC locations for the configured intra-band uplink carrier aggregation in the SCG;

NOTE 0b: The UE does not expect that the reportUplinkTxDirectCurrentTwoCarrier or reportUplinkTxDirectCurrentMoreCarrier is received in both masterCellGroup and in secondaryCellGroup. Network only configures at most one of reportUplinkTxDirectCurrent, reportUplinkTxDirectCurrentTwoCarrier or reportUplinkTxDirectCurrentMoreCarrier in one RRC message.
2> if the RRCReconfiguration message includes the mrdc-SecondaryCellGroupConfig with mrdc-SecondaryCellGroup set to eutra-SCG:
3> include in the eutra-SCG-Response the E-UTRA RRCConnectionReconfigurationComplete message in accordance with TS 36.331clause 5.3.5.3;
2> if the RRCReconfiguration message includes the mrdc-SecondaryCellGroupConfig with mrdc-SecondaryCellGroup set to nr-SCG:
3> include in the nr-SCG-Response the SCG RRCReconfigurationComplete message;
3> if the RRCReconfiguration message is applied due to conditional reconfiguration execution and the RRCReconfiguration message does not include the reconfigurationWithSync in the masterCellGroup:
4> include in the selectedCondRRCReconfig the condReconfigId for the selected cell of conditional reconfiguration execution;
2> if the RRCReconfiguration includes the reconfigurationWithSync in spCellConfig of an MCG:
3> if the UE has logged measurements available for NR and if the RPLMN is included in plmn-IdentityList stored in VarLogMeasReport:
4> include the logMeasAvailable in the RRCReconfigurationComplete message;
4> if Bluetooth measurement results are included in the logged measurements the UE has available for NR:
5> include the logMeasAvailableBT in the RRCReconfigurationComplete message;
4> if WLAN measurement results are included in the logged measurements the UE has available for NR:
5> include the logMeasAvailableWLAN in the RRCReconfigurationComplete message;
3> if the sigLoggedMeasType in VarLogMeasReport is included:
4> if T330 timer is running and the logged measurements configuration is for NR:
5> set sigLogMeasConfigAvailable to true in the RRCReconfigurationComplete message;
4> else:
5> if the UE has logged measurements available for NR:
6> set sigLogMeasConfigAvailable to false in the RRCReconfigurationComplete message;
3> if the UE has connection establishment failure or connection resume failure information available in VarConnEstFailReport or VarConnEstFailReportList and if the RPLMN is equal to plmn-Identity stored in VarConnEstFailReport or in at least one of the entries of VarConnEstFailReportList:
4> include connEstFailInfoAvailable in the RRCReconfigurationComplete message;
3> if the UE has radio link failure or handover failure information available in VarRLF-Report and if the RPLMN is included in plmn-IdentityList stored in VarRLF-Report; or
3> if the UE has radio link failure or handover failure information available in VarRLF-Report of TS 36.331 [10] and if the UE is capable of cross-RAT RLF reporting and if the RPLMN is included in plmn-IdentityList stored in VarRLF-Report of TS 36.331 [10]:
4> include rlf-InfoAvailable in the RRCReconfigurationComplete message;
3> if the UE was configured with successHO-Config when connected to the source Pcell; and
3> if the applied RRCReconfiguration is not due to a conditional reconfiguration execution upon cell selection performed while timer T311 was running, as defined in 5.3.7.3:
4> perform the actions for the successful handover report determination as specified in clause 5.7.10.6, upon successfully completing the Random Access procedure triggered for the reconfigurationWithSync in spCellConfig of the MCG;
3> if the UE has successful handover information available in VarSuccessHO-Report and if the RPLMN is included in plmn-IdentityList stored in VarSuccessHO-Report:
4> include successHO-InfoAvailable in the RRCReconfigurationComplete message;
2> if the RRCReconfiguration message was received via SRB1, but not within mrdc-SecondaryCellGroup or E-UTRA RRCConnectionReconfiguration or E-UTRA RRCConnectionResume:
3> if the UE is configured to provide the measurement gap requirement information of NR target bands:
4> if the RRCReconfiguration message includes the needForGapsConfigNR; or
4> if the NeedForGapsInfoNR information is changed compared to last time the UE reported this information:
5> include the NeedForGapsInfoNR and set the contents as follows:
6> include intraFreq-needForGap and set the gap requirement information of intra-frequency measurement for each NR serving cell;
6> if requestedTargetBandFilterNR is configured:
7> for each supported NR band that is also included in requestedTargetBandFilterNR, include an entry in interFreq-needForGap and set the gap requirement information for that band;
6> else:
7> include an entry in interFreq-needForGap and set the corresponding gap requirement information for each supported NR band;
3> if the UE is configured to provide the measurement gap and NCSG requirement information of NR target bands:
4> if the RRCReconfiguration message includes the needForGapNCSG-ConfigNR; or
4> if the needForGapNCSG-InfoNR information is changed compared to last time the UE reported this information:
5> include the NeedForGapNCSG-InfoNR and set the contents as follows:
6> include intraFreq-needForNCSG and set the gap and NCSG requirement information of intra-frequency measurement for each NR serving cell;
6> if requestedTargetBandFilterNCSG-NR is configured:
7> for each supported NR band included in requestedTargetBandFilterNCSG-NR, include an entry in interFreq-needForNCSG and set the NCSG requirement information for that band;
6> else:
7> include an entry for each supported NR band in interFreq-needForNCSG and set the corresponding NCSG requirement information;
3> if the UE is configured to provide the measurement gap and NCSG requirement information of E UTRA target bands:
4> if the RRCReconfiguration message includes the needForGapNCSG-ConfigEUTRA; or
4> if the needForGapNCSG-InfoEUTRA information is changed compared to last time the UE reported this information:
5> include the NeedForGapNCSG-InfoEUTRA and set the contents as follows:
6> if requestedTargetBandFilterNCSG-EUTRA is configured, for each supported E-UTRA band included in requestedTargetBandFilterNCSG-EUTRA, include an entry in needForNCSG-EUTRA and set the NCSG requirement information for that band; otherwise, include an entry for each supported E-UTRA band in needForNCSG-EUTRA and set the corresponding NCSG requirement information;
2> if this procedure is initiated due to the generation of a complete LTM candidate cell configuration:
3> the procedure ends.

As set out above, RRCReconfigurationComplete message is generated and transmitted to the target LTM candidate cell during LTM execution procedure or when the target LTM cell configuration (indicated by the configuration Identify in the first MAC CE) is applied or upon the reception of the first MAC CE in Option 1, Option 2 or Option 3 (e.g., if the Random Access procedure (or RACH-less solution) is triggered upon the reception of LTM triggering MAC CE).

Option 1, Option 2 or Option 3, set out how to submit the RRCReconfigurationComplete message via which SRB during LTM execution procedure, which is also extended to the dual connectivity scenario (e.g., for UE configured with MCG and SCG). As set out herein, the LTM candidate cell configurations can be configured via SRB1 or split SRB1 or SRB3 by RRCReconfiguration message. The LTM candidate cell configurations for MCG or SCG can be configured via SRB1 or split SRB1 or SRB3 by RRCReconfiguration message. The RRCReconfiguraton message including LTM candidate cell configurations does not include reconfigurationWithSync to avoid RRC message triggered handover.

In another embodiment, RRCReconfiguraton message including LTM candidate cell configurations includes reconfigurationWithSync but it should not trigger a Random access procedure. For MCG case, the generation of RRCReconfiguration can automatically trigger a Random access procedure over cell change. With this reason, especially, for the SCG case (i.e., if the RRCReconfiguration message was received via SRB1 within the nr-SCG within mrdc-SecondaryCellGroup (UE in NR-DC, mrdc-SecondaryCellGroup was received in RRCReconfiguration or RRCResume via SRB1), do not initiate the Random Access procedure on the PSCell if reconfigurationWithSync was included in spCellConfig in NR SCG and if the RRCReconfiguration message is applied due to an LTM cell switch execution. For example, if the scg-State is not included in the RRCReconfiguration or RRCResume message containing the RRCReconfiguration message and if reconfigurationWithSync was included in spCellConfig in nr-SCG and if the RRCReconfiguration message is not applied due to an LTM cell switch execution, UE initiates the Random Access procedure on the PSCell. In another example, if the scg-State is not included in the RRCReconfiguration or RRCResume message containing the RRCReconfiguration message and if reconfigurationWithSync was included in spCellConfig in nr-SCG and if the RRCReconfiguration message is not applied due to an LTM cell switch execution for which a lower layer indicates to skip the Random Access procedure, UE initiates the Random Access procedure on the PSCell.

The UE configured with single connectivity (i.e., MCG only) or not configured with dual connectivity (i.e., MCG and SCG or MCG) can be configured with LTM candidate cell configurations (e.g., for MCG) by the reception of a first RRCReconfiguration message via SRB1. Then, a first RRCReconfigurationComplete message corresponding to the first RRCReconfiguration can be generated and sent to the source serving cell (Master gNB, i.e., MCG) via SRB1 where sent the first RRCReconfiguration message to UE. When UE receives the first MAC CE including the target LTM configuration ID (Identity) from the source serving cell, UE can apply the corresponding target LTM configuration (e.g., for MCG) (or RRCReconfiguration for the target LTM cell of MCG) indicated by the configuration ID in the first MAC CE. Upon the reception of the first MAC CE or the application of the target LTM configuration, UE generates a second RRCReconfigurationComplete corresponding the target LTM configuration with the contents (e.g., configuration ID or information for the target LTM configuration or reply or confirmation) and sends to the target cell (or gNB or MCG) via SRB1. In another embodiment, the second RRCReconfigurationComplete message can be generated when the LTM cell switch (LTM execution) is successfully completed.

Furthermore, the first RRCReconfigurationComplete is submitted as follows (which can be also applied to UE configured with dual connectivity):
1> if the UE is configured with E-UTRA nr-SecondaryCellGroupConfig (UE in (NG)EN-DC):
2> submit the first RRCReconfigurationComplete via E-UTRA;
1> else if the first RRCReconfiguration message was received via SRB3 (UE in NR-DC):
2> if the first RRCReconfiguration message was received within DLInformationTransferMRDC:
3> if the first RRCReconfiguration message was received within the nr-SCG within mrdc-SecondaryCellGroup (NR SCG RRC Reconfiguration):
4> perform SCG reconfiguration accordingly:
3> else (e.g., first RRCReconfiguration message was received within master cell group configuration (NR MCG RRCReconfiguration):
4> submit the first RRCReconfigurationComplete message via SRB1 to lower layers for transmission using the new configuration;
2> else:
3> submit the first RRCReconfigurationComplete message via SRB3 to lower layers for transmission using the new configuration;
1> else (the first RRCReconfiguration was received via SRB1):
2> submit the first RRCReconfigurationComplete message via SRB1 to lower layers for transmission using the new configuration;
The UE configured with dual connectivity (i.e., MCG and SCG) can be configured with LTM candidate cell configurations (e.g., for MCG or SCG) by the reception of a first RRCReconfiguration message via SRB1 (or split SRB1) or SRB3. a first RRCReconfigurationComplete message corresponding to the first RRCReconfiguration can be generated and sent to the source serving cell.

For each case of dual connectivity, how to submit the second RRCReconfigurationComplete is as follows.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if the UE is configured with E-UTRA nr-SecondaryCellGroupConfig (UE in (NG)EN-DC), UE submit the second RRCReconfigurationComplete via E-UTRA. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if the RRCReconfiguration message (or LTM candidate configuration for SCG) was received via SRB1 within the nr-SCG within mrdc-SecondaryCellGroup (UE in NR-DC, mrdc-SecondaryCellGroup was received in RRCReconfiguration or RRCResume via SRB1), UE submits the second RRCReconfigurationComplete message (e.g., to SCG or MCG via SRB1 (or via split SRB1)) via the NR MCG embedded in NR RRC message ULInformationTransferMRDC. In another embodiment, the second RRCReconfigurationComplete message can be generated when the LTM cell switch (LTM execution) is successfully completed.

If a UE is configured with received via SRB3 (UE in NR-DC) and if the RRCReconfiguration message (or LTM candidate configuration for SCG) was received within DLInformationTransferMRDC and if the RRCReconfiguration message was not received within the nr-SCG within mrdc-SecondaryCellGroup (i.e., it's not NR SCG RRC Reconfiguration, or if target LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if the RRCReconfiguration message (or LTM candidate configuration for SCG) was LTM candidate configuration was received within master cell group configuration (i.e., it's NR MCG RRCReconfiguration), UE submits the second RRCReconfigurationComplete message via SRB1 to lower layers for transmission using the new configuration because DLInformationTransferMRDC includes the configuration from MCG, which need to be sent to MCG via SRB1. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if the RRCReconfiguration message (or LTM candidate configuration for SCG) was received via SRB3 (UE in NR-DC) and if the RRCReconfiguration message (or LTM candidate configuration for SCG) was not received within DLInformationTransferMRDC, UE submits the second RRCReconfigurationComplete message via SRB3 to lower layers for transmission using the new configuration because the configuration corresponds to SCG, which need to be sent to SCG via SRB3. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if RRCReconfiguration (or LTM candidate configuration for SCG) was received via SRB1, UE submits the RRCReconfigurationComplete message via SRB1 to lower layers for transmission using the new configuration. In another embodiment, the second RRCReconfigurationComplete message can be generated when the LTM cell switch (LTM execution) is successfully completed.

To implement the details described above, specifically, the UE shall perform the following actions upon reception of the RRCReconfiguration, or upon execution of the conditional reconfiguration (CHO, CPA or CPC) or upon execution of LTM procedure (or LTM cell switch):

if the LTM cell switch is triggered from lower layers (e.g., by receiving the LTM triggering MAC CE in MAC entity or LTM cell switch execution) or if the target LTM candidate cell configuration is applied due to a LTM candidate cell execution:
2> set the content of the second RRCReconfigurationComplete message as follows:
3> include the LTM candidate cell configuration/information (e.g., cell identity or UE identity or configuration index or configuration identity) for the target cell indicated from lower layers (e.g., as indicated by LTM triggering MAC CE)
3> if the RRCReconfiguration message includes the mrdc-SecondaryCellGroupConfig with mrdc-SecondaryCellGroup set to nr-SCG:
4> include in the nr-SCG-Response the SCG RRCReconfigurationComplete message;
4> if the RRCReconfiguration message is applied due to conditional reconfiguration execution and the RRCReconfiguration message does not include the reconfigurationWithSync in the masterCellGroup:
5> include in the selectedCondRRCReconfig the condReconfigId for the selected cell of conditional reconfiguration execution;
4> if the RRCReconfiguration (or target LTM candidate configuration) is applied due to a LTM candidate cell execution for LTM cell switch (e.g., triggered by the reception of the first MAC CE) which can be configured via LTM candidate cell configuration contained in nr-SCG within mrdc-SecondaryCellGroup:
5> include in the selected LTM candidate configuration the configuration Identity (ID) for the selected LTM candidate cell of LTM execution. The configuration ID can be indicated by the first MAC CE;

To ease the network implementation for handling of the second RRCReconfigurationComplete messages, the second RRCReconfigurationComplete is submitted as follows:
1> if the UE is configured with E-UTRA nr-SecondaryCellGroupConfig (UE in (NG)EN-DC):
2> submit the second RRCReconfigurationComplete via E-UTRA;
1> else if the RRCReconfiguration message (or target LTM candidate configuration) was received via SRB1 within the nr-SCG within mrdc-SecondaryCellGroup (UE in NR-DC, mrdc-SecondaryCellGroup was received in RRCReconfiguration orRRCResume via SRB1):
2> if the RRCReconfiguration is applied due to a conditional reconfiguration execution for CPC which is configured via conditionalReconfiguration contained in nr-SCG within mrdc-SecondaryCellGroup; or
2> if the RRCReconfiguration (or target LTM candidate configuration) is applied due to a LTM candidate cell execution for LTM cell switch (e.g., triggered by the reception of the first MAC CE) which can be configured via LTM candidate cell configuration contained in nr-SCG within mrdc-SecondaryCellGroup:
3> submit the second RR CReconfigurationComplete message (e.g., to SCG or MCG via SRB1 (or via split SRB1)) via the NR MCG embedded in NR RRC message ULInformationTransferMRDC, e.g., The UE shall set the contents of the ULInformationTransferMRDC message as follows: if there is a need to transfer MR-DC dedicated information related to NR, UE sets the ul-DCCH-MessageNR to include the NR MR-DC dedicated information to be transferred (e.g., NR RRC MeasurementReport, UEAssistanceInformation, FailureInformation, RRCReconfigurationComplete, MCGFailureInformation, or IABOtherInformation message.
1> else if the RRCReconfiguration message (or target LTM candidate configuration) was received via SRB3 (UE in NR-DC):
2> if the RRCReconfiguration message (or target LTM candidate configuration) was received within DLInformationTransferMRDC:
3> if the RRCReconfiguration message was received within the nr-SCG within mrdc-SecondaryCellGroup (NR SCG RRC Reconfiguration):
4> perform SCG reconfiguration accordingly:
3> else (e.g., target LTM candidate configuration was received within master cell group configuration (NR MCG RRCReconfiguration):
4> submit the second RRCReconfigurationComplete message via SRB1 to lower layers for transmission using the new configuration;
2> else:
3> submit the second RRCReconfigurationComplete message via SRB3 to lower layers for transmission using the new configuration;
1> else (RRCReconfiguration (or target LTM candidate configuration) was received via SRB1):
2> submit the second RRCReconfigurationComplete message via SRB1 to lower layers for transmission using the new configuration;

The DLInformationTransferMRDC message is used for the downlink transfer of RRC messages during fast MCG link recovery via SRB3 while the ULInformationTransferMRDC message is used for the uplink transfer of MR-DC dedicated information via SRB1 or SRB3 (e.g., for transferring the NR or E-UTRA RRC MeasurementReport message, the FailureInformation message, the UEAssistanceInformation message, the RRCReconfigurationComplete message, the IABOtherInformation message or the NR or E-UTRA RRC MCGFailureInformation message).

In another embodiment, the UE configured with dual connectivity (i.e., MCG and SCG) can be configured with LTM candidate cell configurations (e.g., for MCG or SCG) by the reception of a first RRCReconfiguration message via SRB1 (or split SRB1) or SRB3. a first RRCReconfigurationComplete message corresponding to the first RRCReconfiguration can be generated and sent to the source serving cell.

For each case of dual connectivity, how to submit the second RRCReconfigurationComplete is as follows.

If a UE is configured with LTM candidate cell configuration for MCG or if the LTM cell switch is triggered from lower layers (e.g., by receiving the LTM triggering MAC CE from MCG in MAC entity of MCG or LTM cell switch execution in MCG) or if the target LTM candidate cell configuration for MCG is applied due to a LTM candidate cell execution, UE generates the second RRCReconfigurationComplete message. And then, if RRCReconfiguration (or LTM candidate configuration for MCG) was received via SRB1, UE submits the RRCReconfigurationComplete message via SRB1 to lower layers for transmission using the new configuration. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if the RRCReconfiguration message (or LTM candidate configuration for SCG) was received via SRB1 within the nr-SCG within mrdc-SecondaryCellGroup (UE in NR-DC, mrdc-SecondaryCellGroup was received in RRCReconfiguration or RRCResume via SRB1), UE submits the second RRCReconfigurationComplete message (e.g., to SCG or MCG via SRB1 (or via split SRB1)) via the NR MCG embedded in NR RRC message ULInformationTransferMRDC. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if the RRCReconfiguration message (or LTM candidate configuration for SCG) was received via SRB3 (UE in NR-DC) and if the RRCReconfiguration message (or LTM candidate configuration for SCG) was not received within DLInformationTransferMRDC, UE submits the second RRCReconfigurationComplete message via SRB3 to lower layers for transmission using the new configuration because the configuration corresponds to SCG, which need to be sent to SCG via SRB3 and the DLInformationTransferMRDC message is used for the downlink transfer of RRC messages during fast MCG link recovery. In another embodiment, the second RRCReconfigurationComplete message can be generated when the LTM cell switch (LTM execution) is successfully completed.

If a UE is configured with LTM candidate cell configuration for SCG or if the LTM cell switch is triggered from lower layers (e.g., by receiving the LTM triggering MAC CE from SCG in MAC entity of SCG or LTM cell switch execution in SCG) or if the target LTM candidate cell configuration for SCG is applied due to a LTM candidate cell execution, UE generates the second RRCReconfigurationComplete message. And then, if RRCReconfiguration (or LTM candidate configuration for SCG) was received via SRB1, UE submits the RRCReconfigurationComplete message via SRB1 to lower layers for transmission using the new configuration. In another embodiment, the second RRCReconfigurationComplete message can be generated when the LTM cell switch (LTM execution) is successfully completed.

In another embodiment, the UE configured with dual connectivity (i.e., MCG and SCG) can be configured with LTM candidate cell configurations (e.g., for MCG or SCG) by the reception of a first RRCReconfiguration message via SRB1 (or split SRB1) or SRB3. a first RRCReconfigurationComplete message corresponding to the first RRCReconfiguration can be generated and sent to the source serving cell.

For each case of dual connectivity, how to submit the second RRCReconfigurationComplete is as follows.

If a UE is configured with LTM candidate cell configuration for MCG (or SCG) or if the LTM cell switch is triggered from lower layers (e.g., by receiving the LTM triggering MAC CE from MCG (or SCG) in MAC entity of MCG (or SCG) or LTM cell switch execution in MCG (or SCG)) or if the target LTM candidate cell configuration for MCG (or SCG) is applied due to a LTM candidate cell execution, UE generates the second RRCReconfigurationComplete message.

And then, UE submits the second RRCReconfigurationComplete as follows: (In another embodiment, the second RRCReconfigurationComplete message can be generated when the LTM cell switch (LTM execution) is successfully completed).
1> if the UE is in (NG)EN-DC:
2> if SRB3 is configured or the SCG is not deactivated:
3> submit the second RRCReconfigurationComplete via SRB3 to lower layers for transmission, upon which the procedure ends;
2> else:
3> submit the second RRCReconfigurationComplete via E-UTRA embedded in E-UTRA RRC message ULInformationTransferMRDC.
1> else if the UE is in NR-DC:
2> if the LTM candidate cell configuration is associated with the SCG:
3> if SRB3 is configured or the SCG is not deactivated:
4> submit the second RRCReconfigurationComplete via SRB3 to lower layers for transmission, upon which the procedure ends;
3> else:
4> submit the second RRCReconfigurationComplete via SRB1 embedded in NR RRC message ULInformationTransferMRDC;
2> else:
3> submit the second RRCReconfigurationComplete via SRB1 to lower layers for transmission, upon which the procedure ends;
1> else (i.e., UE configured with single connectivity):
2> submit the second RRCReconfigurationComplete to lower layers for transmission, upon which the procedure ends.

In embodiments of this disclosure, LTM execution procedure for SCG can be performed if (or when) the SCG is not deactivated or if (or when) the SCG is activated.

In embodiments of this disclosure, the LTM configuration for candidate cells can indicate the reference configuration for LTM candidate cells or the complete configuration for LTM candidate cells. The reference configuration can be the complete configuration or the reference configuration and a LTM candidate-cell specific configuration can be the complete configuration for the LTM candidate cell.

Upon LTM execution, UE can suspend all radio bearers except SRBs (e.g., SRB0, SRB1, SRB2, SRB3, SRB4 or SRB5), in order to avoid the data processing or data transmission (or reception) to the source cell or to avoid the data transmission in the random access procedure to the target cell. After the successful completion of LTM execution (or LTM cell switch to the target cell), UE can resume all suspended radio bearers except the SRBs to start the data transmission or reception.

The UE shall perform the following actions based on a received LTM-CandidateConfig 1B:
1> store the received ltm-ReferenceConfiguration in VarLTM-Config, if present;
1> if the LTM-CandidateConfig includes the ltm-CandidateToReleaseList:
2> perform the LTM candidate cell release;
1> if the LTM-CandidateConfig includes the ltm-CandidateToAddModList:
2> perform the LTM candidate cell addition or reconfiguration;
1> perform the actions to generate a complete LTM configuration;
NOTE X: It is up to the UE implementation to postpone the generation of a complete LTM configuration until the executing of an LTM cell switch.

The following relates to LTM candidate cell release. The UE shall:
1> for each ltm-Candidateld in the ltm-CandidateToReleaseList:
2> if the current VarLTM-Config includes an ltm-Candidate with the given ltm-Candidateld:
3> release the ltm-Candidate from VarLTM-Config;

The LTM candidate cell configuration can be automatically released by UE in the following cases (or it can be released by the explicit indicator of the received RRC messages):
Upon the successful completion of LTM execution (or LTM cell switch)
Upon the reception of RRCRelease message (because LTM execution is available only in RRC CONNECTED state)
if the RRCSetup is received in response to an RRCReestablishmentRequest (because this means that UE failed to RRC Reestablishment procedure when UE sent an RRCReestablishmentRequest to recover the RRC connection with the network), where The RRCSetup message is used to establish SRB1 and transmitted (or received) via SRB0.

In another embodiment, UE can release the LTM candidate cell configuration upon the reception of RRCRelease message indicating the transition to RRC IDLE mode while UE can store or keep it upon reception of RRCRelease message indicating the transition to RRC INACTIVE mode and it can be re-configured or used to resume RRC connection with RRCResume message. For example, RRCRelease message indicating the state transition to RRC INACTIVE can also indicate UE whether to keep or release the LTM candidate cell configuration. When UE performs RRC Resume procedure, the network can send RRCResume message including an indicator whether to restore or release the LTM candidate cell configuration.

The following relates to LTM candidate cell addition/modification. The UE shall:
1> for each ltm-Candidateld in the ltm-CandidateToAddModList:
2> if the current VarLTM-Config includes an ltm-Candidate with the given ltm-Candidateld:
3> modify the ltm-Candidate within VarLTM-Config in accordance with the received ltm-Candidate;
2> else:
3> add the received ltm-Candidate to VarLTM-Config.

The following relates to Generation of UE LTM configuration. The purpose of this procedure is for the UE to generate a complete LTM candidate cell configuration (or LTM candidate cell configuration) for each LTM candidate cell to be stored and the LTM candidate cell configuration for the target cell indicated by lower layers (i.e., as indicated by LTM triggering MAC CE) is applied only when an indication of an LTM cell switch is received by lower layers. During the generation of a complete LTM candidate cell configuration, the current UE configuration shall not be modified.

The UE shall:
1> for each ltm-Candidate in ltm-CandidateConfigList within VarLTM-Config;
2> store the ltm-Candidateld included in ltm-Candidate within VarLTM-UE-Config;
2> if ltm-Candidate includes ltm-ConfigComplete;
3> generate a complete LTM candidate cell configuration for the received ltm-Candidate according to the actions and store it in ue-LTM-Config within VarLTM-UE-Config.
2> else:
3> generate a complete LTM candidate cell configuration by applying ltm-Candidate on top of referenceConfiguration according to the actions and store it in ue-LTM-Config within VarLTM-UE-Config.

The following relates to LTM cell switch execution. Upon the indication by lower layers that an LTM cell switch procedure is triggered, the UE shall:
1> release/clear all current dedicated radio configuration except for the following:
2> if the LTM cell switch is triggered on the MCG:
the MCG C-RNTI; UE needs to maintain or keep the MCG C-RNTI upon the indication by lower layers that an LTM cell switch procedure is triggered on the MCG as UE may use this RNTI at RLF or at RRC Re-establishment procedure, which can occur during LTM scell switch procedure.
the AS security configurations associated with the master key;
2> else, if the LTM cell switch is triggered on the SCG:

UE doesn't have to keep the SCG C-RNTI as there is no use case for this RNTI during LTM scell switch procedure. (i.e., UE discards (or releases or clears) SCG C-RNTI upon the indication by lower layers that an LTM cell switch procedure is triggered on the SCG)
the AS security configurations associated with the secondary key;
the SRB1/SRB2 configurations and DRB configurations as configured by radioBearerConfig or radioBearerConfig2;
the UE variables VarLTM-Config and VarLTM-UE-Config.
1> release/clear all current common radio configuration associated with the cell group for which the LTM cell switch procedure is triggered;
1> use the default values specified for timers T310, T311 and constants N310, N311 associated with the cell group for which the LTM cell switch procedure is triggered;
1> apply the default L1 parameter values as specified in corresponding physical layer specifications except for the following:
parameters for which values are provided in S1B1(i.e., system information);
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation for SRBs, and with the same security configuration as the PDCP entity for the source cell group;
1> stop timer T310 for the corresponding SpCell, if running;
1> if this procedure is executed for the MCG:
2> if timer T316 is running;
3> stop timer T316;
1> stop timer T312 for the corresponding SpCell, if running;
1> start timer a supervisor timer (i.e., T3xx) for this cell group with the timer value set to the configured value in RRCReconfiguration, as included within the field Itm-Timers;
1> reset the MAC entity of this cell group;
1> apply the specified BCCH configuration for the target LTM candidate cell configuration;
1> acquire the MIB of the target SpCell as indicated in the LTM candidate cell configuration indicated by lower layers, if applicable;
1> apply the LTM configuration in UE-LTM-Config within VarLTM-UE-Config related to the LTM candidate cell configuration identity as received by lower layers.
1> if the value of field Itm-NoResetlD contained within the LTM-Candidate IE related to the LTM candidate cell configuration identity (Target configuration ID) as received by lower layers (i.e., MAC layer) is equal to the value of Itm-ServingCellNoResetID within VarLTM-ServingCellNoResetID:
2> continue using the current RLC entity in the LTM candidate cell configuration indicated by lower layers;
2> replace the value of Itm-ServingCellNoResetID in VarLTM-ServingCellNoResetID with the value received within ltm-NoResetlD;
1> else:
2> for each RLC-BearerConfig within rlc-BearerToAddModList that is part of current UE configuration:
3> re-establish the RLC entity;
2> for each drb-Identity value included in the drb-ToAddModList that is part of the current UE configuration:
3> trigger the PDCP entity of this DRB to perform data recovery;
2> replace the value of ltm-ServingCellNoResetID in VarLTM-ServingCellNoResetID with the value received within ltm-NoResetID;
1> continue using the current PDCP entity in the LTM candidate cell configuration(Target configuration ID) indicated by lower layers (i.e., MAC layer);1> apply the LTM configuration in ue-LTM-Config within VarLTM-UE-Config related to the LTM candidate cell configuration identity as received from lower layers;
1> consider the LTM candidate cell indicated by lower layers to be the serving cell;
1> if the RRCReconfiguration message including the LTM-Candidate IE related to the LTM candidate cell configuration identity (Target configuration ID) as received by lower layers (i.e., MAC layer) was received via SRB1 within the nr-SCG within mrdc-SecondaryCellGroup (UE in NR-DC):
2> submit the RRCReconfigurationComplete message via the NR MCG embedded in NR RRC message ULInformationTransferMRDC;
1> else if RRCReconfiguration message including the LTM-Candidate IE related to the LTM candidate cell configuration identity as received by lower layers was received via SRB3 (UE in NR-DC):
2> submit the RR CReconfigurationComplete message via SRB3 to lower layers for transmission using the new configuration;
1> else (RRCReconfiguration was received via SRB1):
2> submit the RRCReconfigurationComplete message to lower layers for transmission via SRB1 using the new configuration.submit the RRCReconfigurationComplete message to lower layers for transmission using the new configuration.

The LTM cell switch execution procedure above can be extended to cover the dual connectivity case. When UE is configured with dual connectivity (i.e., MCG and SCG). The LTM execution procedure can be initiated in either MCG or SCG. However, note that this procedure would have some impact on MCG failure recovery procedure. The MCG failure recovery is mainly managed by a timer (i.e., T316). The purpose of MCG failure recovery is to inform the network about an MCG failure the UE has experienced i.e., MCG radio link failure, which reports it to MCG via SCG (i.e., via split SRB1 or SRB3) by sending a RRC message (i.e., MCG failure information message). A UE in RRC_CONNECTED, for which AS security has been activated with SRB2 and at least one DRB or multicast MRB setup or, for IAB, SRB2, may initiate the fast MCG link recovery procedure in order to continue the RRC connection without re-establishment. A UE configured with split SRB1 or SRB3 can initiate this procedure to report MCG failures when neither MCG nor SCG transmission is suspended, the SCG is not deactivated, T316 is configured and upon detecting radio link failure of the MCG while T316 is not running. When the MCG failure is informed to MCG, the MCG can send RRC Release message, RRC Reconfiguration message with reconfigurationwithSync (i.e., handover indication) for the PCell, or MobilityFromNRCommand message via SCG (i.e., via split SRB1 or SRB3) to release or recover the RRC connection.

The timer (i.e., T316) can be configured only if the UE is configured with split SRB1 or SRB3. UE starts the timer T316 when UE transmits the RRC message (i.e., MCG Failure Information message). UE submits the MCG Failure Information message to lower layers for transmission via SRB1 if SRB1 is configured as split SRB. Otherwise (i.e., SRB3 configured), UE submits the MCG Failure Information message to lower layers for transmission embedded in NR RRC message ULInformationTransferMRDC via SRB3. UE stops the timer T316 upon receiving RRC Release message, RRC Reconfiguration message with reconfigurationwithSync (i.e., handover indication) for the PCell, MobilityFromNRCommand message, or upon initiating the RRC re-establishment procedure. Upon the expiry of the timer T316, UE initiates the RRC re-establishment procedure.

Considering the MCG failure recovery procedure as set out above, if T316 is running, it means that the MCG failure already happened. Therefore, it is important to carefully consider the case that LTM cell switch execution is initiated when T316 is running. To handle this case efficiently, there are the following options. One of these options can be implemented to proceed LTM execution.

Option 1: In this option, if UE receives the first MAC CE and is going to initiate the LTM cell switch procedure when T316 is running, then UE can stop T316 and perform the LTM cell switch procedure as the LTM cell switch procedure can recover the MCG radio link by cell switching, which may expedite the MCG failure recovery. The corresponding procedure is as follows.

Upon the indication by lower layers that an LTM cell switch procedure is triggered, the UE shall:
1> release/clear all current dedicated radio configuration except for the following:
2> if the LTM cell switch is triggered on the MCG:
the MCG C-RNTI; UE needs to maintain or keep the MCG C-RNTI upon the indication by lower layers that an LTM cell switch procedure is triggered on the MCG as UE may use this RNTI at RLF or at RRC Re-establishment procedure, which can occur during LTM scell switch procedure.
the AS security configurations associated with the master key;
2> else, if the LTM cell switch is triggered on the SCG:

UE doesn't have to keep the SCG C-RNTI as there is no use case for this RNTI during LTM scell switch procedure. (i.e., UE discards (or releases or clears) SCG C-RNTI upon the indication by lower layers that an LTM cell switch procedure is triggered on the SCG)-the AS security configurations associated with the secondary key;
the SRB1/SRB2 configurations and DRB configurations as configured by radioBearerConfig or radioBearerConfig2;
the UE variables VarLTM-Config and VarLTM-UE-Config.
1> release/clear all current common radio configuration associated with the cell group for which the LTM cell switch procedure is triggered;
1> use the default values specified for timers T310, T311 and constants N310, N311 associated with the cell group for which the LTM cell switch procedure is triggered;
1> apply the default L1 parameter values as specified in corresponding physical layer specifications except for the following:
parameters for which values are provided in S1B1 (i.e., system information);
1> apply the value of the newUE-Identity as the C-RNTI for this cell group according to the LTM candidate cell configuration related to the LTM candidate cell configuration identity as received by lower layers;
1> configure lower layers in accordance with the received spCellConfig Common according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation for SRBs, and with the same security configuration as the PDCP entity for the source cell group;
1> stop timer T310 for the corresponding SpCell, if running;
1> if this procedure is executed for the MCG:
2> if timer T316 is running;
3> stop timer T316;
1> stop timer T312 for the corresponding SpCell, if running;
1> start timer a supervisor timer (i.e., T3xx) for this cell group with the timer value set to the configured value in RRCReconfiguration, as included within the field Itm-Timers;
1> reset the MAC entity of this cell group;
1> apply the specified BCCH configuration for the target LTM candidate cell configuration;
1> acquire the MIB of the target SpCell as indicated in the LTM candidate cell configuration indicated by lower layers, if applicable;
1> apply the LTM configuration in UE-LTM-Config within VarLTM-UE-Config related to the LTM candidate cell configuration identity as received by lower layers.
1> if the value of field ltm-NoResetlD contained within the LTM-Candidate IE related to the LTM candidate cell configuration identity (Target configuration ID) as received by lower layers (i.e., MAC layer) is equal to the value of ltm-ServingCellNoResetID within VarLTM-ServingCellNoResetID:
2> continue using the current RLC entity in the LTM candidate cell configuration indicated by lower layers;
2> replace the value of ltm-ServingCellNoResetID in VarLTM-ServingCellNoResetID with the value received within ltm-NoResetlD;
1> else:
2> for each RLC-BearerConfig within rlc-BearerToAddModList that is part of current UE configuration:
3> re-establish the RLC entity;
2> for each drb-Identity value included in the drb-ToAddModList that is part of the current UE configuration:
3> trigger the PDCP entity of this DRB to perform data recovery;
2> replace the value of ltm-ServingCellNoResetID in VarLTM-ServingCellNoResetID with the value received within ltm-NoResetlD;
1> continue using the current PDCP entity in the LTM candidate cell configuration(Target configuration ID) indicated by lower layers (i.e., MAC layer);1> apply the LTM configuration in ue-LTM-Config within VarLTM-UE-Config related to the LTM candidate cell configuration identity as received from lower layers;
1> consider the LTM candidate cell indicated by lower layers to be the serving cell;
1> if the RRCReconfiguration message including the LTM-Candidate IE related to the LTM candidate cell configuration identity (Target configuration ID) as received by lower layers (i.e., MAC layer) was received via SRB1 within the nr-SCG within mrdc-SecondaryCellGroup (UE in NR-DC):
2> submit the RRCReconfigurationComplete message via the NR MCG embedded in NR RRC message ULInformationTransferMRDC;
1> else if RRCReconfiguration message including the LTM-Candidate IE related to the LTM candidate cell configuration identity as received by lower layers was received via SRB3 (UE in NR-DC):
2> submit the RR CReconfigurationComplete message via SRB3 to lower layers for transmission using the new configuration;
1> else (RRCReconfiguration was received via SRB1):
2> submit the RRCReconfigurationComplete message to lower layers for transmission via SRB1 using the new configuration.submit the RRCReconfigurationComplete message to lower layers for transmission using the new configuration.

Option 2: In this option, if UE receives the first MAC CE and is going to initiate the LTM cell switch procedure when T316 is running, then UE does not perform the LTM cell switch procedure as the LTM cell switch procedure may be difficult to be controlled by the CU of the MCG. The LTM cell switch can be triggered by DU of the MCG, which may cause mis-alignment between CU and DU. Note that LTM cell switch can be performed within a cell group. As the running of T316 indicates MCG (Master cell group) radio link failure, UE can wait the response from MCG in the MCG failure recovery procedure, rather than performing LTM cell candidate procedure. The corresponding procedure is as follows.

Upon the indication by lower layers that an LTM cell switch procedure is triggered, if T316 is not running (while T316 is not running), the UE shall:
1> release/clear all current dedicated radio configuration except for the following:
2> if the LTM cell switch is triggered on the MCG:
the MCG C-RNTI; UE needs to maintain or keep the MCG C-RNTI upon the indication by lower layers that an LTM cell switch procedure is triggered on the MCG as UE may use this RNTI at RLF or at RRC Re-establishment procedure, which can occur during LTM scell switch procedure.
the AS security configurations associated with the master key;
2> else, if the LTM cell switch is triggered on the SCG:

UE doesn't have to keep the SCG C-RNTI as there is no use case for this RNTI during LTM scell switch procedure. (i.e., UE discards (or releases or clears) SCG C-RNTI upon the indication by lower layers that an LTM cell switch procedure is triggered on the SCG)-the AS security configurations associated with the secondary key;
the SRB1/SRB2 configurations and DRB configurations as configured by radioBearerConfig or radioBearerConfig2;
the UE variables VarLTM-Config and VarLTM-UE-Config.
1> release/clear all current common radio configuration associated with the cell group for which the LTM cell switch procedure is triggered;
1> use the default values specified for timers T310, T311 and constants N310, N311 associated with the cell group for which the LTM cell switch procedure is triggered;
1> apply the default L1 parameter values as specified in corresponding physical layer specifications except for the following:
parameters for which values are provided in S1B1 (i.e., system information);
1> apply the value of the newUE-Identity as the C-RNTI for this cell group according to the LTM candidate cell configuration related to the LTM candidate cell configuration identity as received by lower layers;
1> configure lower layers in accordance with the received spCellConfigCommon according to the LTM candidate cell configuration indicated by lower layers;
1> configure lower layers in accordance with the received rach-ConfigDedicated according to the LTM candidate cell configuration indicated by lower layers.
1> configure the PDCP entity for LTM candidate cell configuration indicated by lower layers with state variables continuation for SRBs, and with the same security configuration as the PDCP entity for the source cell group;
1> stop timer T310 for the corresponding SpCell, if running;
1> if this procedure is executed for the MCG:
2> if timer T316 is running;
3> stop timer T316;
1> stop timer T312 for the corresponding SpCell, if running;
1> start timer a supervisor timer (i.e., T3xx) for this cell group with the timer value set to the configured value in RRCReconfiguration, as included within the field Itm-Timers;
1> reset the MAC entity of this cell group;
1> apply the specified BCCH configuration for the target LTM candidate cell configuration;
1> acquire the MIB of the target SpCell as indicated in the LTM candidate cell configuration indicated by lower layers, if applicable;
1> apply the LTM configuration in UE-LTM-Config within VarLTM-UE-Config related to the LTM candidate cell configuration identity as received by lower layers.
1> if the value of field Itm-NoResetlD contained within the LTM-Candidate IE related to the LTM candidate cell configuration identity (Target configuration ID) as received by lower layers (i.e., MAC layer) is equal to the value of Itm-ServingCellNoResetID within VarLTM-ServingCellNoResetID:
2> continue using the current RLC entity in the LTM candidate cell configuration indicated by lower layers;
2> replace the value of Itm-ServingCellNoResetID in VarLTM-ServingCellNoResetID with the value received within ltm-NoResetlD;
1> else:
2> for each RLC-BearerConfig within rlc-BearerToAddModList that is part of current UE configuration:
3> re-establish the RLC entity;
2> for each drb-Identity value included in the drb-ToAddModList that is part of the current UE configuration:
3> trigger the PDCP entity of this DRB to perform data recovery;
2> replace the value of ltm-ServingCellNoResetID in VarLTM-ServingCellNoResetID with the value received within ltm-NoResetID;
1> continue using the current PDCP entity in the LTM candidate cell configuration(Target configuration ID) indicated by lower layers (i.e., MAC layer);1> apply the LTM configuration in ue-LTM-Config within VarLTM-UE-Config related to the LTM candidate cell configuration identity as received from lower layers;
1> consider the LTM candidate cell indicated by lower layers to be the serving cell;
1> if the RRCReconfiguration message including the LTM-Candidate IE related to the LTM candidate cell configuration identity (Target configuration ID) as received by lower layers (i.e., MAC layer) was received via SRB1 within the nr-SCG within mrdc-SecondaryCellGroup (UE in NR-DC):
2> submit the RRCReconfigurationComplete message via the NR MCG embedded in NR RRC message ULInformationTransferMRDC;
1> else if RRCReconfiguration message including the LTM-Candidate IE related to the LTM candidate cell configuration identity as received by lower layers was received via SRB3 (UE in NR-DC):
2> submit the RR CReconfigurationComplete message via SRB3 to lower layers for transmission using the new configuration;
1> else (RRCReconfiguration was received via SRB1):
2> submit the RRCReconfigurationComplete message to lower layers for transmission via SRB1 using the new configuration.submit the RRCReconfigurationComplete message to lower layers for transmission using the new configuration.

For the above options, UE can stop T310 and T312 when LTM execution is initiated as these timers are used to monitor radio link. For example, UE starts T310 upon detecting physical layer problems for the SpCell, i.e., upon receiving pre-configured number of consecutive out-of-sync indications from lower layers, stops it upon receiving several consecutive in-sync indications from lower layers for the SpCell, upon receiving RRCReconfiguration with reconfigurationWithSync for that cell group, upon reception of MobilityFromNRCommand, upon the reconfiguration of rlf-TimersAndConstant, upon initiating the connection re-establishment procedure, upon conditional reconfiguration execution, i.e., when applying a stored RRCReconfiguration message including reconfigurationWithSync for that cell group, upon initiating the MCG failure information procedure, and upon LTM cell switch execution. For example, UE starts T312 if T312 is configured in MCG, upon triggering a measurement report for a measurement identity for which T312 has been configured and useT312 value has been set to true, while T310 in PCell is running and UE stops T312 upon receiving pre-configured number of consecutive in-sync indications from lower layers for the SpCell, receiving RRCReconfiguration with reconfigurationWithSync for that cell group, upon reception of MobilityFromNRCommand, upon initiating the RRC re-establishment procedure, upon the reconfiguration of rlf-TimersAndConstant, upon initiating the MCG failure information procedure, upon conditional reconfiguration execution, i.e., when applying a stored RRCReconfiguration message including reconfigurationWithSync for that cell group, upon the expiry of T310 in corresponding SpCell, upon SCG release, if the T312 is kept in SCG, if T312 is configured in SCG and useT312 has been set to true, upon triggering a measurement report for a measurement identity for which T312 has been configured, or and upon LTM cell switch execution or while T310 in PSCell is running.

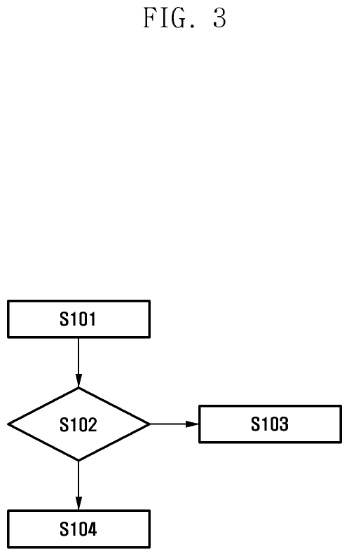

FIG. 3 shows a flowchart representing a method according to an embodiment of the disclosure.

At operation S101, a UR is communicatively connected in a Dual Connectivity, DC, configuration to a Master Node, MN, or master Cell Group, MCG, and a Secondary Node, SN, or Secondary Cell Group, SCG, At operation S102, a determination is made if LTM is triggered for MN/MCG or SN/SCG.

If triggered for MN/MCG, then, at operation S103, the UE maintains MCG Cell-Radio Network Temporary Identifier, C-RNTI, and clears or releases other current dedicated radio configurations associated with a cell group for which the LTM procedure is triggered.

If triggered for SN/SCG, then, at operation S104, the UE clears or releases current dedicated radio configuration associated with a cell group for which the LTM procedure is triggered.

According to an embodiment, a method of performing L1/L2 Triggered Mobility, LTM, in a User Equipment, UE, communicatively connected in a Dual Connectivity, DC, configuration to a Master Node, MN, or master Cell Group, MCG, and a Secondary Node, SN, or Secondary Cell Group, SCG, is provided, wherein: if LTM is triggered for the MN or MCG, then the UE maintains MCG Cell-Radio Network Temporary Identifier, C-RNTI, and clears or releases other current dedicated radio configurations associated with a cell group for which the LTM procedure is triggered; or if LTM is triggered for the SN or SCG, then the UE clears or releases current dedicated radio configuration associated with a cell group for which the LTM procedure is triggered.

According to an embodiment, wherein if LTM is triggered for the MN or MCG, then one of the other current dedicated radio configurations associated with a cell group for which the LTM procedure is triggered includes SCG C-RNTI.

According to an embodiment, wherein if LTM is triggered for the SN or SCG, then conditions for parameters set in an RRC message and instructions of a lower layer are satisfied only to trigger a random access procedure.

According to an embodiment, wherein, upon receipt of an RRCReconfiguration message by the UE, determining if scg-State is included in the RRCReconfiguration message and if not, determining if reconfigurationWihSync is included in spCellConfig in nr-SCG and if the RRCReconfiguration message is not applied due to an LTM cell switch execution for which a lower layer indicates to skip the Random Access procedure, then initiate a Random Access procedure on the PSCell.

According to an embodiment, a method performed by a user equipment (UE) in a communication system is provided.

According to an embodiment, the method includes receiving a radio resource control (RRC) message including a configuration of layer 1/layer 2 (L1/L2) triggered mobility (LTM) associated with LTM cell switch procedure; identifying that the LTM cell switch procedure is triggered; and releasing current dedicated radio configuration associated with a cell group for which the LTM cell switch procedure is triggered.

According to an embodiment, wherein, in case that the LTM cell switch procedure is triggered on a master cell group (MCG), the current dedicated radio configuration is released except for an MCG cell radio network temporary identifier (C-RNTI).

According to an embodiment, wherein, in case that the LTM cell switch procedure is triggered on the MCG, the current dedicated radio configuration is released further except for access stratum (AS) security configurations associated with a master key.

According to an embodiment, wherein, in case that the LTM cell switch procedure is triggered on a secondary cell group (SCG), the released current dedicated radio configuration includes an SCG C-RNTI.

According to an embodiment, wherein, in case that the LTM cell switch procedure is triggered on an SCG, the current dedicated radio configuration is released except for AS security configurations associated with a secondary key.

According to an embodiment, wherein the RRC message is an RRCReconfiguration message.

According to an embodiment, wherein a random access procedure on a primary secondary cell (PSCell) is initiated in case that scg-State is not included in the RRCReconfiguration message, reconfigurationWithSync was included in spCellConfig in nr-SCG, and the RRCReconfiguration message is not applied due to an LTM cell switch execution for which a lower layer indicates to skip the random access procedure.

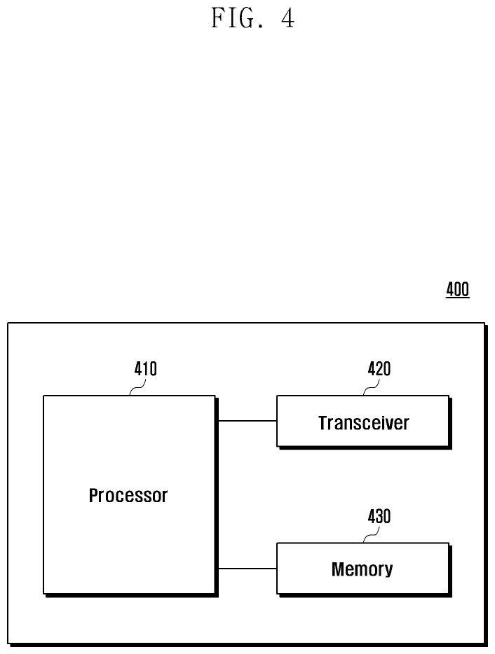

FIG. 4 illustrates an electronic device according to an embodiment of the disclosure.

Referring to FIG. 4, an electronic device 400 may include a processor 410, a transceiver 420 and a memory 430. However, all of the illustrated components are not essential. The electronic device 400 may be implemented by more or less components than those illustrated in FIG. 4. In addition, the processor 410 and the transceiver 420 and the memory 430 may be implemented as a single chip according to another embodiment.

The electronic device 400 may correspond to the UE described above.

The aforementioned components will now be described in detail.

The processor 410 may include one or more processors or other processing devices that control the proposed function, process, and/or method. Operation of the electronic device 400 may be implemented by the processor 410.

The transceiver 420 may include a RF transmitter for up-converting and amplifying a transmitted signal, and a RF receiver for down-converting a frequency of a received signal. However, according to another embodiment, the transceiver 420 may be implemented by more or less components than those illustrated in components.

The transceiver 420 may be connected to the processor 410 and transmit and/or receive a signal. The signal may include control information and data. In addition, the transceiver 420 may receive the signal through a wireless channel and output the signal to the processor 410. The transceiver 420 may transmit a signal output from the processor 410 through the wireless channel.

The memory 430 may store the control information or the data included in a signal obtained by the electronic device 400. The memory 430 may be connected to the processor 410 and store at least one instruction or a protocol or a parameter for the proposed function, process, and/or method. The memory 430 may include read-only memory (ROM) and/or random access memory (RAM) and/or hard disk and/or CD-ROM and/or digital versatile disc (DVD) and/or other storage devices.

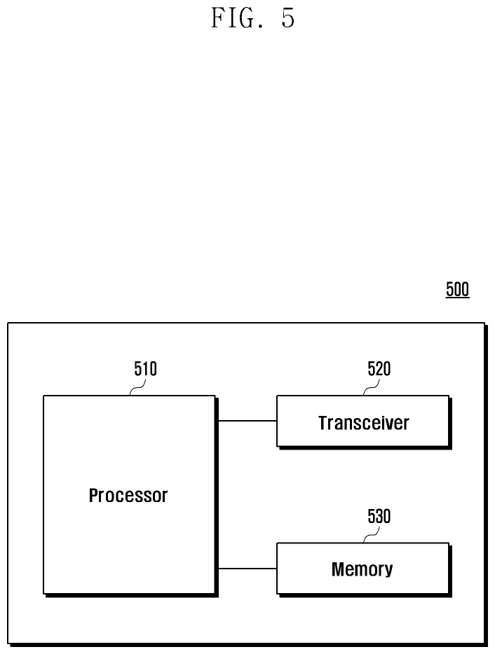

FIG. 5 illustrates a base station according to an embodiment of the disclosure.

Referring to FIG. 5, a base station 500 may include a processor 510, a transceiver 520 and a memory 530. However, all of the illustrated components are not essential. The base station 500 may be implemented by more or less components than those illustrated in FIG. 5. In addition, the processor 510 and the transceiver 520 and the memory 530 may be implemented as a single chip according to another embodiment.

The base station 500 may correspond to the gNB described above.

The aforementioned components will now be described in detail.

The processor 510 may include one or more processors or other processing devices that control the proposed function, process, and/or method. Operation of the base station 500 may be implemented by the processor 510.

The transceiver 520 may include a RF transmitter for up-converting and amplifying a transmitted signal, and a RF receiver for down-converting a frequency of a received signal. However, according to another embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the base station 500. The memory 530 may be connected to the processor 510 and store at least one instruction or a protocol or a parameter for the proposed function, process, and/or method. The memory 530 may include read-only memory (ROM) and/or random access memory (RAM) and/or hard disk and/or CD-ROM and/or DVD and/or other storage devices.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving a radio resource control (RRC) message including a configuration of layer 1 (L1)/layer 2 (L2) triggered mobility (LTM) associated with a LTM cell switch procedure;
identifying that the LTM cell switch procedure is triggered; and
releasing current dedicated radio configuration associated with a cell group for which the LTM cell switch procedure is triggered,
wherein, in case that the LTM cell switch procedure is triggered on a master cell group (MCG), the current dedicated radio configuration is released except for an MCG cell radio network temporary identifier (C-RNTI).

2. The method of claim 1, wherein, in case that the LTM cell switch procedure is triggered on the MCG, the current dedicated radio configuration is released further except for access stratum (AS) security configurations associated with a master key.

3. The method of claim 1, wherein, in case that the LTM cell switch procedure is triggered on a secondary cell group (SCG), the released current dedicated radio configuration includes an SCG C-RNTI.

4. The method of claim 1, wherein, in case that the LTM cell switch procedure is triggered on a secondary cell group (SCG), the current dedicated radio configuration is released except for access stratum (AS) security configurations associated with a secondary key.

5. The method of claim 1,
wherein the RRC message is an RRCReconfiguration message, and
wherein a random access procedure on a primary secondary cell (PSCell) is initiated in case that a secondary cell group (SCG)-State is not included in the RRCReconfiguration message, reconfigurationWithSync was included in spCellConfig in nr-SCG, and the RRCReconfiguration message is not applied due to an LTM cell switch execution for which a lower layer indicates to skip the random access procedure.

6. A user equipment (UE) in a communication system, the UE comprising:
a transceiver; and
a processor coupled with the transceiver and configured to:
receive a radio resource control (RRC) message including a configuration of layer 1 (L1)/layer 2 (L2) triggered mobility (LTM) associated with a LTM cell switch procedure,
identify that the LTM cell switch procedure is triggered, and
release current dedicated radio configuration associated with a cell group for which the LTM cell switch procedure is triggered,
wherein, in case that the LTM cell switch procedure is triggered on a master cell group (MCG), the current dedicated radio configuration is released except for an MCG cell radio network temporary identifier (C-RNTI).

7. The UE of claim 6, wherein, in case that the LTM cell switch procedure is triggered on the MCG, the current dedicated radio configuration is released further except for access stratum (AS) security configurations associated with a master key.

8. The UE of claim 6, wherein, in case that the LTM cell switch procedure is triggered on a secondary cell group (SCG), the released current dedicated radio configuration includes an SCG C-RNTI.

9. The UE of claim 6, wherein, in case that the LTM cell switch procedure is triggered on a secondary cell group (SCG), the current dedicated radio configuration is released except for access stratum (AS) security configurations associated with a secondary key.

10. The UE of claim 6,
wherein the RRC message is an RRCReconfiguration message, and
wherein a random access procedure on a primary secondary cell (PSCell) is initiated in case that secondary cell group (SCG)-State is not included in the RRCReconfiguration message, reconfigurationWithSync was included in spCellConfig in nr-SCG, and the RRCReconfiguration message is not applied due to an LTM cell switch execution for which a lower layer indicates to skip the random access procedure.

11. A method performed by a base station in a communication system, the method comprising:
obtaining a configuration of layer 1 (L1)/layer 2 (L2) triggered mobility (LTM) associated with a LTM cell switch procedure; and
transmitting a radio resource control (RRC) message including the configuration,
wherein, in case that the LTM cell switch procedure is triggered on a master cell group (MCG), a current dedicated radio configuration is released except for an MCG cell radio network temporary identifier (C-RNTI).

12. The method of claim 11, wherein, in case that the LTM cell switch procedure is triggered on the MCG, the current dedicated radio configuration is released further except for access stratum (AS) security configurations associated with a master key.

13. The method of claim 11, wherein, in case that the LTM cell switch procedure is triggered on a secondary cell group (SCG), the released current dedicated radio configuration includes an SCG C-RNTI.

14. The method of claim 11, wherein, in case that the LTM cell switch procedure is triggered on a secondary cell group (SCG), the current dedicated radio configuration is released except for access stratum (AS) security configurations associated with a secondary key.

15. The method of claim 11,
wherein the RRC message is an RRCReconfiguration message, and
wherein a random access procedure on a primary secondary cell (PSCell) is initiated in case that secondary cell group (SCG)-State is not included in the RRCReconfiguration message, and reconfigurationWithSync was included in spCellConfig in nr-SCG.

16. A base station in a communication system, the base station comprising:
a transceiver; and
a processor coupled with the transceiver and configured to:
obtain a configuration of layer 1 (L1)/layer 2 (L2) triggered mobility (LTM) associated with a LTM cell switch procedure, and
transmit a radio resource control (RRC) message including the configuration,
wherein, in case that the LTM cell switch procedure is triggered on a master cell group (MCG), a current dedicated radio configuration is released except for an MCG cell radio network temporary identifier (C-RNTI).

17. The base station of claim 16, wherein, in case that the LTM cell switch procedure is triggered on the MCG, the current dedicated radio configuration is released further except for access stratum (AS) security configurations associated with a master key.

18. The base station of claim 16, wherein, in case that the LTM cell switch procedure is triggered on a secondary cell group (SCG), the released current dedicated radio configuration includes an SCG C-RNTI.

19. The base station of claim 16, wherein, in case that the LTM cell switch procedure is triggered on a secondary cell group (SCG), the current dedicated radio configuration is released except for access stratum (AS) security configurations associated with a secondary key.

20. The base station of claim 16,
wherein the RRC message is an RRCReconfiguration message, and
wherein a random access procedure on a primary secondary cell (PSCell) is initiated in case that a secondary cell group (SCG)-State is not included in the RRCReconfiguration message, and reconfigurationWithSync was included in spCellConfig in nr-SCG.
